(19) United States
(12) Patent Application Publication
(10) Pub. No.: US 2013/0300859 A1
(43) Pub. Date: Nov. 14, 2013

(54) ALL-PURPOSE PORTABLE TESTER FOR ISOLATION CHARACTER OF THE SURFACE OF THE COMPOSITE BUSHING MADE FROM SILICON RUBBER

(71) Applicants: Jiang Qian, Yuncheng (CN); Jianjie Chen, Yuncheng (CN); Zhigang Chen, Yuncheng (CN); Jiping Jin, Yuncheng (CN); Jinsheng Mao, Yuncheng (CN); Guofan Sun, Yuncheng (CN)

(72) Inventors: Jiang Qian, Yuncheng (CN); Jianjie Chen, Yuncheng (CN); Zhigang Chen, Yuncheng (CN); Jiping Jin, Yuncheng (CN); Jinsheng Mao, Yuncheng (CN); Guofan Sun, Yuncheng (CN)

(21) Appl. No.: 13/979,330

(22) PCT Filed: Jan. 9, 2012
(86) PCT No.: PCT/CN2012/000028

§ 371 Date: Jul. 29, 2013

(30) Foreign Application Priority Data
Sep. 16, 2011 (CN) 201110286392.9

(51) Int. Cl. H04N 7/18

(52) U.S. Cl. CPC H04N 7/18
USPC 348/125

(57) ABSTRACT

The all-purpose portable tester for isolation character of the surface of the composite bushing made from silicon rubber applies to detecting and estimating hydrophobicity and isolation performances, the length and width and density of the cracking, comprehensive assessment of the surface of the umbrella skirt and bushing and to detecting the tracking and the electric corrosion of silicon rubber, being made up of Master Control Unit, Principal Computer, Hydrophobicity Detection Unit, Crack Detection Unit, Tracking Detection Unit and Electric Corrosion Detection Unit and Image Capture Unit through which the comprehensive diagnosis and life assessment of the isolation character of the surface of the composite bushing made from silicon rubber shall be achieved.

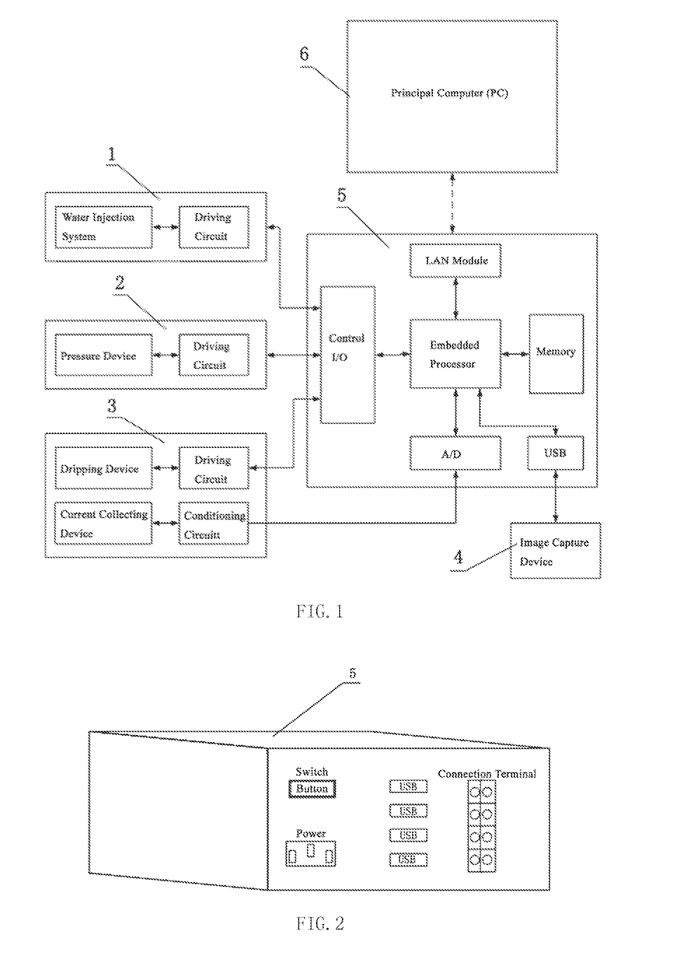

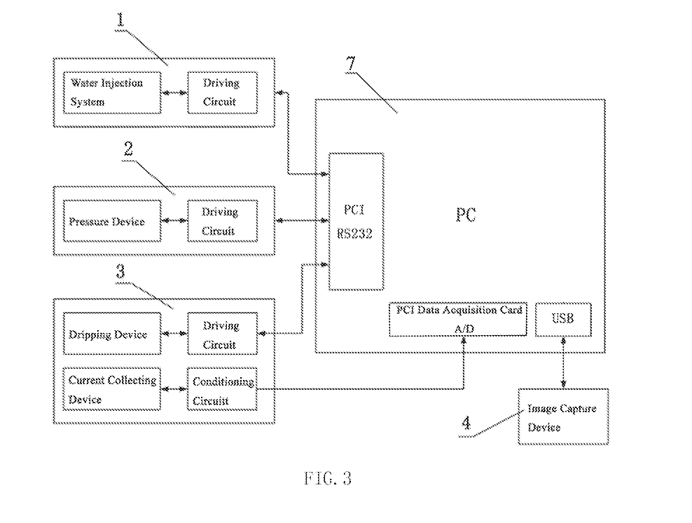

### PRIORITY CLAIM

This application is a 371 filing from PCT/CN2012/000028 filed Jan. 9, 2012, which claims priority from Chinese Patent Application No. CN102435920A filed Sep. 16, 2011, the disclosures of which are hereby incorporated by reference.

### TECHNICAL FIELD

The invention of the All-purpose Portable Tester for isolation character of the surface of the composite bushing made from silicon rubber belongs to high-voltage technology field.

### BACKGROUND

The composite insulated bushing made from silicon rubber has been widely used in arrester, circuit breaker, transformers, mutual inductor, high-voltage switch, bushing and terminal cable sheath because it has so many advantages such as high insulation properties, good hydrophobicity, excellent stain resistance, high explosion-proof properties. In recent years, as the composite insulated bushing made from silicon rubber is being used rapidly, the situation which silicon rubber has been deteriorated and damaged deteriorated gradually. Due to different factories, different technologies and different materials, the quality of the products is different in many ways. At the same time, deterioration phenomenon takes place in the isolation character of the surface of the composite bushing made from silicon rubber under the condition of long-period strong electric field, pollution, high humidity, intensive ultraviolet, long sunshine, large temperature difference and so on.

It is difficult to diagnose and detect the operating the composite insulated bushing made from silicon rubber because the means of operation and maintenance and detecting are imperfect and without on-site testing and diagnostic device. If we do nothing about it, the security operation of power system will suffer serious threat.

### SUMMARY

The purpose of this invention is mainly in solving the problem mentioned above and providing the All-purpose Portable Tester for isolation character of the surface of the composite bushing made from silicon rubber.

To achieve the purpose mentioned above, the technology scheme of this invention is like this: The All-purpose Portable Tester for isolation character of the surface of the composite bushing made from silicon rubber is made up of master control unit, detection unit, capture unit and principal computer. It is characterized in that: When master control unit (5) receives the executing command of principal computer (6), it will drive connecting hydrophobicity detection unit (1) and image capture unit (4) to get the testing image data of hydrophobicity detection (1) and the data will be sent to the principal computer (6) for storage and analysis. The hydrophobicity detection unit (1) consists of water injection system and driving circuit.

Master control unit (5) also can connect crack detection unit (2) for the tester mentioned above. When master control unit (5) receives the executing command of principal computer (6), it will drive connecting crack detection unit (2) and image capture unit (4) to get the testing image data of crack detection unit (2) and the data will be sent to the principal computer (6) for storage and analysis. Crack detection unit (2) is made up of pressure device and driving circuit.

Master control unit (5) also can connect tracking and electric corrosion detection unit (3) for the tester mentioned above. When master control unit (5) receives the executing command of principal computer (6), it will get the return current data of connecting tracking and electric corrosion detection unit (3) and the data will be sent to the principal computer (6) for storage and analysis. Tracking and electric corrosion detection unit (3) is made up of dripping device, driving circuit, current collecting device and conditioning circuit.

Principal computer (6) is PC, which is responsible for basic parameters configure and commands operation order sending and data receiving. The captured data will be sent to it for storage and analysis. Communication part adopts wireless area network.

Master control unit (5) is made up of embedded processor, AID converter, wireless LAN port module, memory module, I/O interface and USB port It adopts real-time operating system.

Master control unit (5) and principal computer (6) also can be replaced by PC (7) for the tester mentioned above. By doing away with partial wireless area network, PC (7) will finish all function of principal computer (6) and master control unit (5).

Compared with existing technology, the invention has some advantages like this:

(1) small, light, easy transportation.

(2) distributed structure, centralized control, easy operation.

(3) Depending the functions of software management to analyze and process test data and compare the test data over the years, achieving synthetic diagnosis and life evaluation for isolation character of the surface of the composite bushing made from silicon rubber, efficient data processing.

(4) simple processing , low cost , easier to use.

Next, I will describe this invention through embodiments and appended drawings in detail.

### BRIEF DESCRIPTION OF THE DRAWINGS

Appended drawing 1 is structural sketch map of embodiment 1.

Appended drawing 2 is shape structural map of master control unit in embodiment 1.

Appended drawing 3 is structural map of embodiment 2.

Icon Instruction:
1. Hydrophobicity Detection Unit
2. Crack Detection Unit
3. Tracking and Electric Corrosion Detection Unit
4. Image Capture Unit
5. Master Control Unit
6. Principal Computer
7. PC

### DETAILED DESCRIPTION OF THE DRAWINGS

Appended drawing 1 is structural sketch map of embodiment 1. This invention is made up of principal computer (6), master control unit (5), hydrophobicity detection unit (1), crack detection unit (2), tracking and electric corrosion detection unit (3) and image capture unit (4).The process of this invention is like this: At first, when master control unit (5) receives the executing command of principal computer (6), it will drive connecting hydrophobicity detection unit (1) and crack detection unit (2), and then image capture unit (4) will get the testing image data of hydrophobicity detection unit (1) and crack detection unit (2) and return current data of tracking and electric corrosion detection unit (3). Image data and return current data are both sent by master control unit (5) for storage and analysis.

Hydrophobicity detection unit (1) is made up of water injection system .Crack detection unit (2) is made up of pressure device and driving circuit. Tracking and electric corrosion detection unit (3) is made up of dripping device, driving device, current collecting device and conditioning circuit.

Principal computer (6) is PC, which is responsible for basic parameters configure and command operation order sending and data receiving, adopting wireless area network for communication parts, storing and analyzing the captured data, depending the functions of software management to analyze and process test data and compare the test data over the years, achieving synthetic diagnosis and life evaluation for isolation character of the surface of the composite bushing made from silicon rubber.

Master control unit (5) is made up of embedded processor, A/D converter, memory module, I/O interface port and USB port. It adopts real-time operating system. Appended drawing 2 is shape structural map of master control unit in embodiment 1. There are switch button, power socket, USB port and connection terminal on the panel.

Appended drawing 3 is structural map of embodiment 2. It differs from embodiment 1, for it does away with the part of wireless transmission. Master control unit (5) and principal computer (6) can be replaced by PC (7) for the tester mentioned above, doing away with partial wireless area network, and PC (7) will finish all function of principal computer (6) and master control unit (5). The whole tester is made up of PC (7), hydrophobicity detection unit (1), crack detection unit (2), tracking and electric corrosion detection unit (3) and image capture unit (4). The interface RS232 of PC is connected with driving circuit of hydrophobicity detection unit (1), crack detection unit (2) and tracking and electric corrosion detection unit (3).The data acquisition card A/D of PC is connected with conditioning circuit of tracking and electric corrosion detection unit (3). The USB port of PC is connected with image capture device.

1-5. (canceled)

6. An all-purpose portable tester for isolation character of a surface of a composite bushing made from silicon rubber comprises: a master control unit, a detection unit, a capture unit, and a principal computer, wherein the master control unit receives an executing command of the principal computer and drives a connecting crack detection unit and image capture unit to obtain testing image data of the crack detection unit, said data being sent to the principal computer for storage and analysis, wherein the crack detection unit is made up of a pressure device and a driving circuit.

7. The all-purpose portable tester of claim 6, wherein the master control unit receives the executing command of the principal computer to return current data of a tracking and electric corrosion detection unit, the data being sent to the principal computer for storage and analysis, said tracking and electric corrosion detection unit made up of a dripping device, a driving circuit, a current collecting device, and a conditioning circuit.

8. The all-purpose portable tester of claim 6, wherein the master control unit and principal computer comprise a principal computer.
